(19) United States
(12) Patent Application Publication
(10) Pub. No.: US 2022/0151878 A1
(43) Pub. Date: May 19, 2022

(54) Studded Pacifier

(71) Applicants: Stephanie Gonseneuaskas, Montreal (CA); Bharath Rajakumar, Montreal (CA)

(72) Inventors: Stephanie Gonseneuaskas, Montreal (CA); Bharath Rajakumar, Montreal (CA)

(21) Appl. No.: 17/493,999

(22) Filed: Oct. 5, 2021

Related U.S. Application Data
(60) Provisional application No. 63/115,349, filed on Nov. 18, 2020.

(51) Int. Cl. A61J 17/00

(52) U.S. Cl. CPC A61J 17/10; A61J 17/001

(57) ABSTRACT

This present invention relates to an improved pacifier to inhibit thrush among infants or toddlers using pacifiers. The improved pacifier features a studded nipple that allows the infants to massage their own tongue via the bumps and studs on the nipple surface, and therefore inhibits thrush and other oral infections. Additionally, the pacifier of the present invention features a protruding ridge that acts as a chin guard, that helps the infant to retain the pacifier in the mouth and inhibit the pacifier from falling out of the mouth and dropping on the ground. The uniquely designed studded nipple pacifier ensures an infant remains calm and comfortable without worry of dropping their pacifier.

### CROSS-REFERENCE TO RELATED APPLICATION

The present application claims priority to, and the benefit of, U.S. Provisional Application No. 63/115,349, which was filed on Nov. 18, 2020 and is incorporated herein by reference in its entirety.

### FIELD OF THE INVENTION

The present invention relates generally to the field of pacifiers for infants and toddlers. More specifically, the present invention relates to an improved pacifier featuring a studded nipple and a chin guard for infants and toddlers. When in use, the improved pacifier allows a child to massage their own tongue via the bumps and studs on the nipple to inhibit thrush. The improved pacifier utilizes a protruding rubber ridge that acts as a chin guard, which helps in retaining the pacifier in a child's mouth. The improved pacifier ensures a child remains calm and comfortable without worry of dropping the pacifier. Additionally, the improved pacifier eliminates the need for parents to use finger brushes or wet cloths to clean out the mouth and tongue of their child to combat thrush. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, pacifiers, in one form or another, have been in existence for a long period of time and are used to calm and comfort infants and toddlers. A pacifier, also known as a soother, teether, or binky, is an artificial nipple made up of rubber, plastic or silicon. The nipple is typically attached to a handle for grasping and holding. Usually, a pacifier is used to pacify an annoyed and irritable baby. Additionally, pacifiers can be used to inhibit a baby from sudden infant death syndrome (SIDS) and suffocation during sleep. Further, pacifiers have been extensively used for distracting babies during general fussiness, sickness, while travelling or in other similar situations to satisfy babies' excessive urges for sucking.

Infants and toddlers that frequently use standard pacifiers can be susceptible to thrush. Oral thrush is a common infection in babies which is caused by a fungus called Candida (Can-did-ah). Thrush in the mouth begins as tiny flat white spots that can combine together and form “cheesy” white patches that can cover the tongue, gums, sides and/or roof of the mouth. To overcome thrush, parents or other individuals have to attempt to fit a wet cloth or finger brush in the mouth to wipe down thrush. However, using a wet cloth or finger brush cannot completely resolve thrush issues in infants, thereby causing parents to seek medical help for their infants. This can cause inconvenience to both infants and their parents.

Additionally, when an infant sucks the nipple of a pacifier, due to lack of ample suction on the pacifier or due to intermittent suction, the pacifier can frequently fall out of the child's mouth and drop on the ground. Once the pacifier drops on the ground, it becomes dirty and unhygienic for reuse. Parents may have to constantly replace their child's pacifier, or clean the pacifier properly, to inhibit transmission of germs and spread of diseases to their infants.

Therefore, there exists a long felt need in the art for a pacifier that can be used frequently to calm down and comfort irritable and annoyed infants. There is also a long felt need in the art for a pacifier that does not cause thrush in the mouth of infants. Additionally, there is a long felt need in the art for a pacifier that eliminates the need for parents to clean white patches inside their child's mouth due to thrush. There is also a long felt need in the art for a pacifier that eliminates the need to use a wet cloth or finger brushes to clean the mouth and tongue of infants, and that enables infants to massage their own tongue to inhibit thrush. Moreover, there is a long felt need in the art for a pacifier that enables infants to create a grip with the pacifier which allows the infants to use the pacifiers, uninterrupted, for longer periods of time. Further, there is a long felt need in the art for a pacifier that will not fall out of an infant's mouth and drop on the ground. Furthermore, there is a long felt need in the art for a pacifier that will not become dirty and unhygienic from falling, thereby inhibiting transmission of germs. Finally, there is a long felt need in the art for a modified pacifier that helps in retaining the pacifier in a child's mouth without tactile intervention.

The subject matter disclosed and claimed herein, in one embodiment thereof, comprises a studded nipple pacifier with an integrated chin guard. The pacifier further comprises: a nipple having tiny studs or bumps on the surface; a ring; a mouth shield having an interior surface to which the nipple is attached; an exterior surface to which the ring is attached; and a chin guard integrated along a bottom edge of the mouth shield to abut against a chin of an infant; and, the chin guard is configured to inhibit the pacifier from falling out of an infant's mouth. It is to be appreciated that the studs or bumps, on the exterior surface of the nipple, allow and encourage an infant to massage their own tongue to inhibit thrush.

In this manner, the novel studded nipple pacifier of the present invention accomplishes all of the forgoing objectives, and provides a relatively safe, easy and convenient solution to calm down and comfort annoyed and irritable infants and toddlers. The studded nipple pacifier of the present invention is also infant-friendly, inasmuch as the pacifier is comfortable to use and provides a retention mechanism to maintain the pacifier in an infant's mouth, thereby enabling infants to suck the pacifier, uninterrupted, for longer periods of time. Additionally, the studded nipple pacifier allows infants to massage their tongue through the use of the herein described pacifier, thereby prohibiting the contracting of thrush. The pacifier of the present invention also eliminates the need for parents or caregivers to clean the tongue and mouth of the infants/toddlers.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a studded nipple pacifier with an integrated chin guard. The pacifier further comprises: a nipple having tiny studs or bumps on the surface; a ring; a mouth shield having an interior surface to which the nipple is attached; an exterior surface to which the ring is attached; and a chin guard integrated along a bottom edge of the mouth shield to abut against the chin of an infant; and, the chin guard is configured to inhibit the pacifier from falling out of an infant's mouth. The studs or bumps, on the exterior surface of the nipple, enable and encourage an infant to massage their own tongue to inhibit thrush.

In a further embodiment of the present invention, the infant pacifier is configured to inhibit thrush formation inside an infant's mouth while using the pacifier as described. The pacifier comprises: a nipple having a top surface and a bottom surface; the bottom surface having a plurality of tiny studs or bumps formed thereon to provide a massaging surface for the tongue of an infant to inhibit thrush; the top surface has a smooth non-studded surface to provide a smooth feeling on the palate; a mouth shield having openings to facilitate breathing; and, a rubber, silicon or plastic ridge adjacent to a bottom edge of the mouth shield conformable to the chin of the infant and configured to inhibit the pacifier from falling out of the infant's mouth and to facilitate retention of the pacifier in the infant's mouth.

In yet a further embodiment of the present invention, a thrush inhibiting pacifier is disclosed and comprises: a shield member having one or more holes to facilitate breathing; the shield member having an interior surface to which a studded nipple is attached and an exterior surface to which a ring is attached through a connector; the studded nipple having a plurality of studs/bumps or ridges on some portion or all portions of the nipple surface thereby providing a massage surface for an infant's tongue to inhibit thrush; and, a protruding rubber ridge along a bottom area of the shield member to provide a retention mechanism for maintaining the pacifier in the child's mouth and thus inhibiting expulsion therefrom.

The studded nipple pacifier of the present invention provides infants and toddlers with an improved pacifier featuring a studded nipple and a chin guard. The studs allows children to massage their own tongue by moving the tongue over and around the bumps and studs to inhibit thrush. The pacifier of the present invention eliminates the need for parents to use finger brushes or wet cloths to clean out the mouth and tongue of the child to combat thrush. The pacifier disclosed herein utilizes a protruding rubber or plastic ridge that acts as a chin guard to help in retaining the pacifier in a child's mouth. The pacifier ensures that a child remains calm and comfortable without worry of dropping the pacifier.

In other illustrative embodiments, the pacifier can have a clip to attach to any backpack, pocket or other similar item for easy portability. Also, the mouth shield is sized to avoid the possibility of a child swallowing the pacifier. The mouth shield covers the lips, and some part of the chin proximal to the lips, to provide adequate support to retain the pacifier in the mouth of an infant or child. The material of the pacifier inhibits the growth of odor-causing bacteria, mold and mildew.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a studded nipple pacifier of the present invention in accordance with the disclosed architecture;

FIG. 2 illustrates a bottom isometric view of a studded nipple pacifier of the present invention in accordance with the disclosed architecture;

FIG. 3 illustrates a front isometric view of a studded nipple pacifier of the present invention in accordance with the disclosed architecture;

FIG. 4 illustrates a front isometric view of another potential embodiment of a studded nipple pacifier of the present invention in accordance with the disclosed architecture;

FIG. 5 illustrates a perspective view of still another potential embodiment of a studded nipple pacifier of the present invention having a bulb-shaped nipple in accordance with the disclosed architecture; and

FIG. 6 illustrates a side view of a child using a studded nipple pacifier of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a pacifier that can be used frequently to calm down and comfort irritable and annoyed infants. There is also a long felt need in the art for a pacifier that does not cause thrush in an infant's mouth. Additionally, there is a long felt need in the art for a pacifier that eliminates the need for parents to clean white patches inside an infant's mouth due to thrush. There is also a long felt need in the art for a pacifier that eliminates the need to use a wet cloth or finger brushes to clean the mouth and tongue of infants. There is a long felt need in the art for a pacifier that enables infants to massage their own tongue and independently inhibit thrush. Moreover, there is a long felt need in the art for a pacifier that enables infants to create a grip with the pacifier and that allows infants to use the pacifiers for longer periods of time without tactile intervention. Further, there is a long felt need in the art for a pacifier that inhibits expulsion from an infant's mouth and thereby limiting the number of occasions when the pacifier comes into contact with an unsanitary surface. Furthermore, there is a long felt need in the art for a pacifier that reduces the chances of the pacifier becoming dirty and unhygienic, and therefore inhibits the transmission of germs. Finally, there is a long felt need in the art for a modified pacifier that can more easily be retained in a child's mouth.

The present invention, in one exemplary embodiment, is a novel studded nipple pacifier with an integrated chin guard comprising: a nipple having tiny studs or bumps on the surface; a ring; a mouth shield having an interior surface to which the nipple is attached and an exterior surface to which the ring is attached; and, the chin guard integrated along a bottom edge of the mouth shield to about a chin of an infant and configured to inhibit expulsion of the pacifier from the infant's mouth. The studs or bumps enable and encourage an infant to move the tongue over and around the studs to provide a massage thereto and to inhibit thrush.

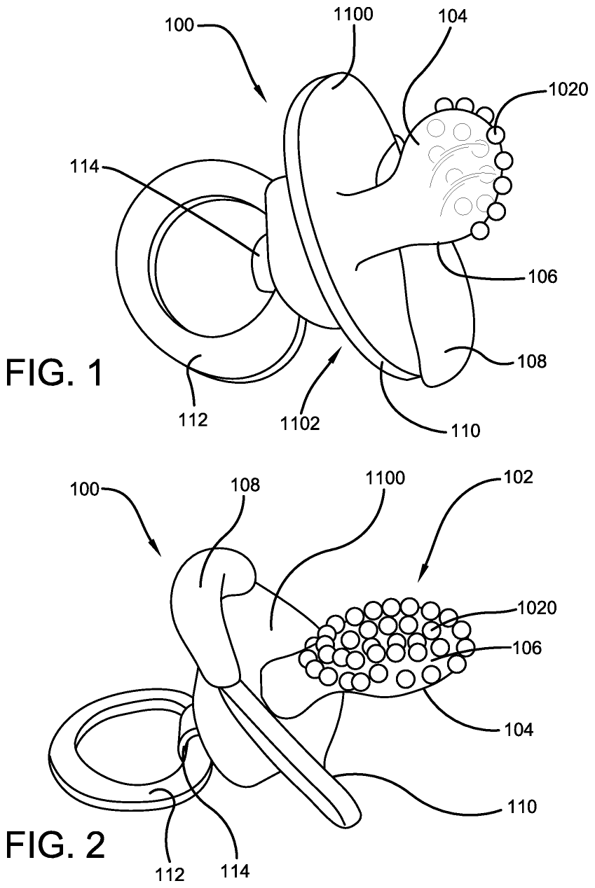

Referring initially to the drawings, FIG. 1 illustrates a perspective view of one potential embodiment of a studded nipple pacifier of the present invention in accordance with the disclosed architecture. The studded nipple pacifier 100 includes a mouth shield 110 having a substantially planar body. Further, the mouth shield 110 includes an interior surface 1100 oriented towards the mouth of a user when the studded nipple pacifier 100 is in use. The mouth shield 110 further includes an exterior surface 1102 to which a ring or handle 112 can be attached through a connector 114.

A studded nipple or sucking body 102 in the shape of an orthodontic nipple comprises an upper portion 104 and a lower portion 106. The nipple 102 extends generally orthogonal away from the interior surface 1100 of the mouth shield 110. In one potential embodiment, the upper portion 104 does not include any studs, bumps, or ridges and thereby provides a smooth surface against the palate of an infant or toddler. The lower portion 106 of the studded nipple 102 can include a plurality of tiny studs or bumps 1020 allowing the infant or toddler to massage the tongue by moving it over and around the bumps and studs 1020, thereby inhibiting thrush. A child void of thrush eliminates the need for parents to use finger brushes or wet cloths to clean out their child's mouth and tongue. Also, the nipple 102 can provide an imitation of the properties of a human breast nipple. The studded nipple 102 is firmly attached to the interior surface 1100, or molded thereto, to prevent ingestion of the studded nipple 102 by an infant or a toddler.

Along the bottom edge of the mouth shield 110, a chin guard 108 is provided and comprises a protruding rubber ridge mounted to or formed with the interior surface 1100 of the shield 110. The chin guard 108 helps in retaining the pacifier 100 in the child's mouth. The chin guard 108 can be securely placed under, and abutted to, the chin of a child when using the pacifier 100. When a child pauses a suction force on the pacifier 100 during use, the pacifier 100, by way of gravity, begins to rotate downwards and starts the expulsion from the child's mouth. The chin guard 108 helps the infant or toddler retain the pacifier 100 by prohibiting this rotational movement due to the contact between the guard 108 and the child's chin. In one illustrative example, the chin guard 108 can be made up of neodymium polyisoprene rubber.

The studded pacifier 100 of the present invention is made from materials free from PVC, BPA, artificial coloring, chemical softeners, phthalates and nitrosamines. The studded pacifier 100 can come in different sizes that are appropriate for infants and toddlers up to several years old.

FIG. 2 illustrates a bottom isometric view of a studded nipple pacifier of the present invention in accordance with the disclosed architecture. The chin guard 108 in the form of a rubber ridge, for example, comprises a width greater than the width of the mouth shield 110. The guard 108 can extend continuously along a bottom edge 109 of the mouth shield 110 and protrudes inward away from the interior surface 1100 such that the chin of an infant or a toddler rests on and against the chin guard 108 which inhibits expulsion of the pacifier 100. It is to be appreciated that the guard 108 includes a first portion 118 and a second portion 120. The first portion 118 of the chin guard abuts a front area of a user's chin when the nipple 102 is in the user's mouth. The second portion 120 of the chin guard 108 abuts a bottom area of a user's chin when the nipple 102 is in the user's mouth The lower portion 106 of the studded nipple 102 includes tiny studs or ridges 1020 that contact the tongue of a child or an infant and inhibit thrush when the child's tongue is moved over and around the ridges 1020. A ring 112 can be attached to the exterior surface 1102 of the shield 110 through a connector 114.

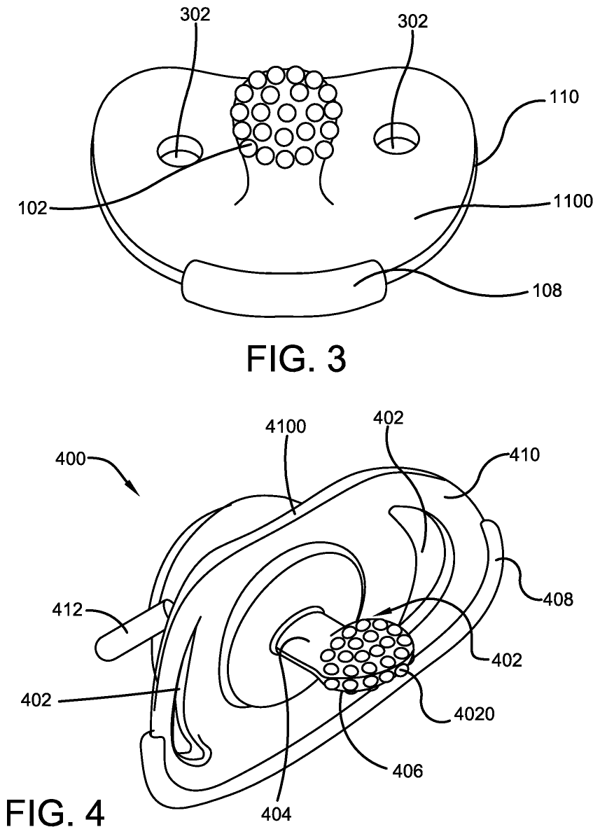

FIG. 3 illustrates a front isometric view of a studded nipple pacifier of the present invention in accordance with the disclosed architecture. The mouth shield 110 includes two openings 302, one on each side of the attached nipple 102, to facilitate breathing of the child while using the studded nipple pacifier 100. The openings 302 can be more than two as per the requirements and needs of the child. The mouth shield 110 can be of any shape such as a heart shape or oval shape. The studded nipple 102 used in the pacifier 100 can be suitably attached to, or integrated with, the interior surface 1100 of the mouth shield 110, and can include any number of different shapes, sizes, and materials such as latex or silicone. The studded nipple 102 extends generally longitudinally from, and orthogonal to, the mouth shield 110 for insertion into the infant's mouth. Along the bottom edge 109 of the mouth shield 110, a chin guard 108 can be integrated there along. The chin guard 108, utilizes a protruding rubber ridge extending inwardly and away from the interior surface 1100. The guard 108, when in contact with a child's chin, inhibits rotational movement of the pacifier 100. Rotational movement is due to gravity or incidental pushing of the child's tongue against the nipple 102. By inhibiting rotational movement of the pacifier 100, expulsion of the pacifier 100 from a child's mouth can be minimized. Maintaining the pacifier 100 in a child's mouth assists in keeping the child calm and comfortable without the worry of dropping the pacifier 100.

FIG. 4 illustrates a front isometric view of another potential embodiment of a studded nipple pacifier of the present invention in accordance with the disclosed architecture. In the present embodiment, a mouth shield 410 includes a flat upper edge 4100 and two openings 402 for facilitating breathing. A grip or handle 412 is present on the exterior side of the mouth shield 410 and can be used for handling the pacifier 400. A studded nipple 402 attached to the mouth shield 410 includes a top surface 404 and a bottom surface 406. Both the top surface 404 and the bottom surface 406 have studs or bumps 4020 to provide massaging stimuli to inhibit contracting of thrush and to allow the child to massage the tongue over and around the studs or bumps 4020. An integrated chin guard 408 can be present along a bottom edge 409 of the mouth shield 410 to abut against the chin of an infant and help to retain the pacifier 400 in the infant's mouth. It is to be appreciated that the shield 410 comprises an area and that the chin guard 408 comprises an area. The chin guard area is generally about 5 percent to about 30 percent of the shield area. The chin guard 408 can be made up of silicon or soft plastic and can conform to the shape of the bottom edge 409 of the chin guard 408.

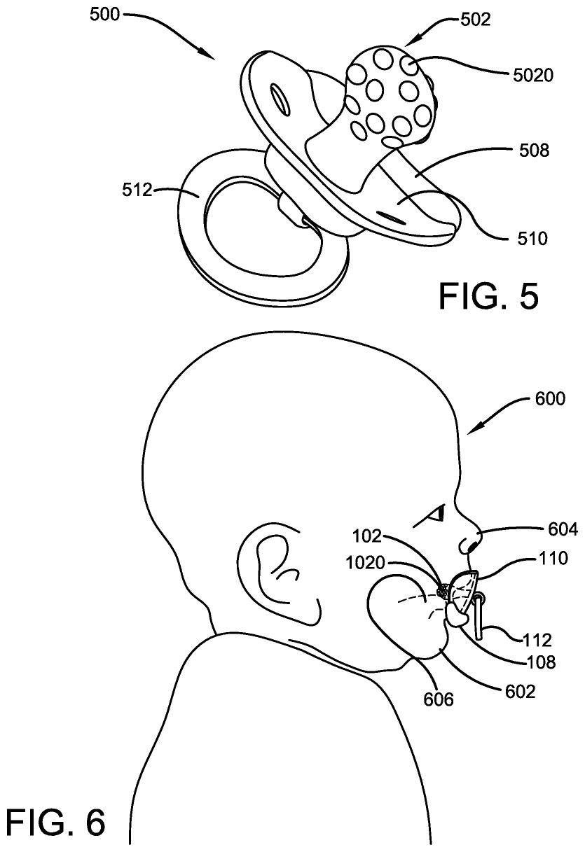

FIG. 5 illustrates a perspective view of still another potential embodiment of another studded nipple pacifier of the present invention having a bulb shaped nipple in accordance with the disclosed architecture. The pacifier 500 of the embodiment shown in FIG. 5, includes a bulb shaped nipple or sucking body 502 having studs or bumps 5020 over a majority of the exterior surface. At the bottom of the mouth shield 510, a silicon or rubber ridge 508 is present on which the chin of an infant using the pacifier 500 rests, thereby inhibiting the pacifier 500 from being expelled from an infant's mouth. A ring 512 can also be present, similar to a conventional pacifier, for the infant or child to hold the pacifier 500 by the individual's fingers.

FIG. 6 illustrates a side view of a child using a studded nipple pacifier of the present invention in accordance with the disclosed architecture. As shown, the chin guard 108 conforms to the chin 602 of the child 600 and inhibits the pacifier 100 from rotating and falling. The mouth shield 110 covers the lips and is sized to be present under the nose 604 of the child 600. The studs 1020 present on the surface of the nipple 102 provide a massaging surface for the tongue 606 of the child 600. Continual movement of a child's tongue 606 over and around the studs 1020 inhibits contracting thrush and other diseases. The chin guard 108 securely grips to the chin 602 and obstructs the rotation and falling of the pacifier 100 out of a child's mouth. The chin guard 108 can be of a material that is soft to the skin and that does not cause any irritation.

It should be noted that the pacifier of all embodiments of the present invention can come as a single unit or come in modular parts with replaceable nipple or ring. The chin guard can also be removably attached to the bottom edge of the shield member in one embodiment. The pacifier can come in a plurality of colors and sizes to meet requirements of children of different ages. The pacifier of the present invention allows the infant to breathe easily without removing the pacifier and withstands the pressure of chewing and excessive sucking by the infant. The studs also help in providing a texture that mimics a human nipple.

In one embodiment, the studded nipple can have a flavor to encourage use of the pacifier by an infant. The studs can also activate the taste buds of the child in addition to inhibiting thrush. Suction is not always required by the child to retain the pacifier in their mouth due to the presence of the novel chin guard.

Certain terms are used throughout the following description and claims to refer to particular features or components. As one skilled in the art will appreciate, different persons can refer to the same feature or component by different names. This document does not intend to distinguish between components or features that differ in name but not structure or function. As used herein “pacifier”, “modified pacifier”, “studded nipple pacifier”, “infant pacifier” and “thrush inhibiting pacifier” are interchangeable and refer to the studded nipple pacifier 100 of the present invention.

Notwithstanding the forgoing, the studded nipple pacifier 100, 400, 500 of the present invention can be of any suitable size and configuration as is known in the art without affecting the overall concept of the invention, provided that it accomplishes the above stated objectives. One of ordinary skill in the art will appreciate that the size, configuration and material of the studded nipple pacifier 100, 400, 500 as shown in the FIGS. are for illustrative purposes only, and that many other sizes and shapes of the studded nipple pacifier 100, 400, 500 are well within the scope of the present disclosure. Although the dimensions of the studded nipple pacifier 100, 400, 500 are important design parameters for user convenience, the studded nipple pacifier 100, 400, 500 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pacifier comprising:
a shield;
a nipple and a chin guard integrally formed with said shield;
said nipple comprising an exterior surface including an upper portion and a lower portion;
said lower portion including a plurality of studs protruding from said exterior surface;
said chin guard comprising a first portion and a second portion; and
said first portion of said chin guard abutting a front area of a user's chin when said nipple is in a user's mouth.

2. The pacifier of claim 1, wherein said second portion of said chin guard abuts a bottom area of the user's chin when said nipple is in the user's mouth.

3. The pacifier of claim 2, wherein said upper portion including a plurality of studs protruding from said exterior surface.

4. The pacifier of claim 3, wherein said upper portion of said plurality of studs and said lower portion of said plurality of studs comprise a majority of said exterior surface.

5. The pacifier of claim 4, wherein said shield comprises a shield width and said chin guard comprises a chin guard width, and further wherein said chin guard width is greater than said shield width.

6. The pacifier of claim 5, wherein said nipple is bulb shaped.

7. The pacifier of claim 5, wherein said shield comprises a shield area and said chin guard comprises a chin guard area, and further wherein said chin guard area is less than said shield area.

8. The pacifier of claim 7, wherein said chin guard area is generally about 5 percent to about 30 percent of said shield area.

9. A pacifier comprising:
a shield;
a nipple and a chin guard integrally formed with said shield;
said nipple comprising an exterior surface including an upper portion and a lower portion;
said lower portion including a plurality of studs protruding from said exterior surface;
said chin guard comprising a first portion and a second portion;
said first portion of said chin guard abutting a front area of a user's chin when said nipple is in the user's mouth; and
said shield comprises a width and said chin guard comprises a width, and wherein said chin guard width is greater than said shield width.

10. The pacifier of claim 9, wherein said second portion of said chin guard abutting a bottom area of a user's chin when said nipple is in the user's mouth.

11. The pacifier of claim 10, wherein said upper portion including a plurality of studs protruding from said exterior surface.

12. The pacifier of claim 11, wherein said upper portion of said plurality of studs and said lower portion of said plurality of studs comprise a majority of said exterior surface.

13. The pacifier of claim 12, wherein said nipple is bulb shaped.

14. The pacifier of claim 13, wherein said shield comprises a shield area and said chin guard comprises a chin guard area, and further wherein said chin guard area is less than said shield area.

15. The pacifier of claim 14, wherein said chin guard area is generally about 5 percent to about 30 percent of said shield area.

16. A pacifier comprising:
a shield;
a nipple and a chin guard integrally formed with said shield;
said nipple comprising an exterior surface including an upper portion and a lower portion;
said lower portion including a plurality of studs protruding from said exterior surface;
said chin guard comprising a first portion and a second portion;
said first portion of said chin guard abutting a front area of a user's chin when said nipple is in the user's mouth;
said shield comprises an area and said chin guard comprises an area; and
said chin guard area is generally about 5 percent to about 30 percent of said shield area.

17. The pacifier of claim 16, wherein said second portion of said chin guard abutting a bottom area of a user's chin when said nipple is in the user's mouth.

18. The pacifier of claim 17, wherein said upper portion including a plurality of studs protruding from said exterior surface.

19. The pacifier of claim 18, wherein said shield comprises a width and said chin guard comprises a width, and said chin guard width is greater than said shield width.

20. The pacifier of claim 19, wherein said upper portion of said plurality of studs and said lower portion of said plurality of studs comprise a majority of said exterior surface.
